(19) United States
(12) Patent Application Publication
(10) Pub. No.: US 2014/0173539 A1
(43) Pub. Date: Jun. 19, 2014

(54) Method and Apparatus for Isolating and/or Debugging Defects in Integrated Circuit Designs

(71) Applicant: CADENCE DESIGN SYSTEMS, INC., San Jose, CA (US)

(72) Inventors: David Guoqing Zhang, San Jose, CA (US); Tsair-Chin Lin, San Jose, CA (US)

(73) Assignee: CADENCE DESIGN SYSTEMS, INC., San Jose, CA (US)

(21) Appl. No.: 13/719,559

(22) Filed: Dec. 19, 2012

(51) Int. Cl. G06F 17/50

(52) U.S. Cl. CPC G06F 17/5009
USPC 716/106

(57) ABSTRACT

Method and apparatus for debugging aspects of integrated circuit (IC) designs employ techniques by which defective intellectual property (IP) in those IC designs can be exercised, and defects identified, without disturbing the IP itself, but at the same time isolating the source of the defect(s) to the responsible IP provider(s). The IP provider then can debug the IP. In one aspect, the techniques give the IP provider(s) specific information about the nature of the defect, facilitating the provider's efforts to debug the IP.

### CROSS-REFERENCE TO RELATED APPLICATION

The present application is related to commonly-assigned application Ser. No. ______, entitled “Method and Apparatus for Verifying Debugging of Integrated Circuit Designs,” Attorney Docket No. 13335/12054, filed on the same day as the present application. The contents of that related application are incorporated herein by reference.

### BACKGROUND

The present invention relates to integrated circuit designs, and in particular to techniques for isolating defects in such designs so as to enable identifying the defects with particular sources. The invention also relates to debugging and verification of debugging of identified defects.

Integrated circuit (IC) designers do not always design every component of an IC. While IC designers may design one or more components of a particular IC, these designers often employ IC component designs (also known as intellectual property, or IP) from one or more third-party IP providers. Sourcing of IC component designs from third-party IP providers can facilitate overall design by avoiding the need for the IC designer to design every aspect of the IC's functionality. However, out-sourcing of IC component designs also can complicate debugging, because the origin of defects in the overall IC design can be unclear, for a variety of reasons.

IC designers may employ a hardware based verification platform to perform certain operations on an IC design. Such platforms are well known in the art, and so is the usage of such platforms, so that details need not be provided here. Hardware verification platforms can enable the presentation of real runtime scenarios occurring inside an IC. Such presentations can facilitate design analysis and debugging. When defects are encountered, an IC designer can do a data dump of the information of interest, and can analyze the data in order to identify the source of any defects.

Where third-party IP providers are involved, it is desirable to place debugging responsibility with the third party who provided the functionality in question. However, in a situation in which there are multiple IP component sources in the design, it can be difficult to know which IP provider to approach, and which IP provider to whom to give the data dump, or which portion of the data dump. Also, given the amount of data and consequent analysis involved, it can be difficult to convince an IP provider that its particular IP component design was responsible for the defect(s) encountered.

Even where multiple IP components come from the same source, it can be difficult to know which portion of a data dump would be relevant to effect the necessary debugging. Moreover, without sufficient guidance as to the potential or probable source of the problems, a given IP provider will tend to resist incurring significant effort to assist in debugging, particularly when the volume of data in the data dump is substantial and generally undirected. The resulting process is inefficient.

Viewed another way, IC designers can compile a large amount of runtime state information for an IC design, and can provide that information to third-party IP providers. However, without the ability to establish that a particular third-party IP provider's design component is a source of a defect, it is difficult to get the third-party IP provider to take responsibility for the defect, and thereby take responsibility for fixing the defect.

If IC designers had access to details of the third-party IP provider design components, proving defect origins would be easier. However, those design component details often are proprietary, and consequently the third-party IP providers hold onto those details tightly. As a result, IC designers cannot reliably match design component details with the runtime state information.

Another issue with respect to compiled runtime state information is potential ambiguity with respect to paths a finite state machine (one way of viewing an IC component or group of such components) might take to get to a particular state. There may be multiple paths, one or more of which might be the source of a defect. Just looking at an appropriate portion of a data dump might not resolve the ambiguity so as to lead to resolution of the defect source.

Once the appropriate IP provider takes responsibility for a defect and sets about to fix it, the provider must overcome various obstacles. Among these is the state ambiguity referred to above.

Once the defect is fixed, it is necessary for the IP provider to convince the IP consumer that the fix will work under a sufficient number of different circumstances. Consequently, it is desirable to input the repaired IP into a suitable test bench, and run appropriate scenarios, with combinations of input states, so as to demonstrate to the IP consumer that the fix will hold, without the IP provider revealing any of its proprietary IP in the course of the interaction with the IP consumer.

### BRIEF SUMMARY OF THE INVENTION

In view of the foregoing, it is one object of the present invention to provide a facility for isolating defects so as to enable an IP consumer to identify reliably the IP provider responsible for the functionality that needs to be debugged, without the consumer being privy to the provider's proprietary IP.

In accordance with one aspect of the present invention, a hardware verification system contains information that enables data tracing that is specific to a particular IP provider, based on IP specific tracing requirements, or IPSTRs, that the IP provider makes available. When the hardware verification system encounters defects, the system is able to use the IPSTRs to obtain data dumps that are specific to the component or components to which the IPSTRs relate. The IC designer need not be aware of the IPSTRs, so that no proprietary information need be made visible. Moreover, in one aspect the IP provider can provide IPSTRs without making proprietary information available.

IPSTRs also may have utility in a situation in which data streams are being generated which create ambiguity as to a source of a particular defect or defects. However, in this aspect of the invention, IPSTRs are not essential, particularly where the IP at issue is being provided in connection with implementation of a hardware or software standard.

In a situation in which the IP in question is being provided in accordance with a standard, as may happen, for example, in the case of Bluetooth™, Wi-Fi, other communications, memory management, display, or other functionality in a device (e.g. a tablet, a smartphone, a notebook or desktop computer, or the like), and a defect provides or leads to an indication that the standard is not being complied with, the IP provider then can recognize the issue as stemming from the provider's own IP, and can address the issue without having to reveal proprietary information about the IP.

There may be circumstances in which compliance with a particular standard can implicate different IP providers. In accordance with one aspect of the present invention, the appropriate IP provider is identified, based on tracing that is carried out with respect to the IC component design for which the IP provider is responsible.

In accordance with another aspect of the present invention, where non-compliance with a standard becomes apparent through identification of one or more defects, and/or the IP for the standard in question is readily seen to have come from a single source, IPSTRs may not be necessary in order to enable the IC designer to route defect correction to the appropriate IP provider.

### BRIEF DESCRIPTION OF THE DRAWINGS

FIG. 1 depicts a device having an IC with various IP design components.

FIG. 2 depicts a high level diagram of hardware and its connection over a network, to perform debugging and proof of efficacy thereof, in accordance with one aspect of the invention.

FIG. 3 depicts a flow chart in accordance with one aspect of the present invention.

FIGS. 4A and 4B depict examples of triggering environments and conditions in accordance with aspects of the present invention.

FIGS. 5A and 5B depict finite state machines in accordance with aspects of the present invention.

### DETAILED DESCRIPTION

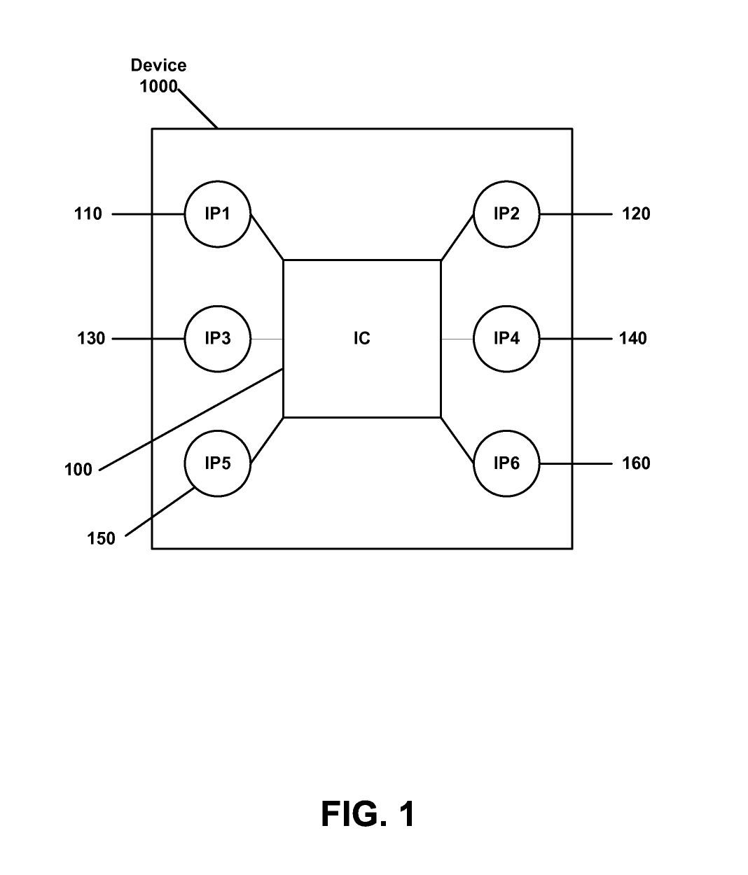

In FIG. 1, device 1000, which may be, for example, a mobile phone (including but not limited to a smartphone), a tablet, or a computer of some kind, includes one or more ICs 100 with IP design components IP1-1P6 labeled, for convenience, 110-160. Looking for example at a smartphone, a non-exhaustive list of IP design components could include memory (static or dynamic, general-purpose or special-purpose); display graphics; audio; video; power management; various wired communication and/or bus protocols including but not limited to PCI Express, members of the PCI Express family, and/or variants thereof, in different applications depending on the data communications need; wireless communications protocols including but not limited to cellular (e.g. GSM/CDMA), Bluetooth™, Wi-Fi (some form of 802.11), WIMAX (some form of 802.16); various connection protocols including but not limited to different forms of USB (different versions, micro-USB, mini-USB, and the like), video connection protocols (e.g. Thunderbolt (which might be one example of a PCI Express application), HDMI, or others) or other connector types which may or may not be proprietary; and/or image processing (e.g. on-board camera functionality). All of these various elements could be provided in a single IC (for example, in a system on a chip (SoC), or other IC incorporating IP from multiple providers, or multiple types of IP from a single provider), or could be contained in multiple ICs.

While some of the IP design components mentioned above may be proprietary, a number of them may be developed according to a standard, be it wired or wireless communications, audio, video, memory, or others. Different IP providers can and will have different ways of implementing a particular standard. Some of these IP design components may interrelate and/or interoperate. That is, some of these components may rely on performance of other components in order to function properly. For example, graphics processing may rely on special-purpose graphics memory, or additionally may rely on some portion of general purpose memory in order to perform in an optimal manner. The interrelation and interoperation in particular may contribute substantially to difficulties in isolating a defect and attributing it to a specific IP provider.

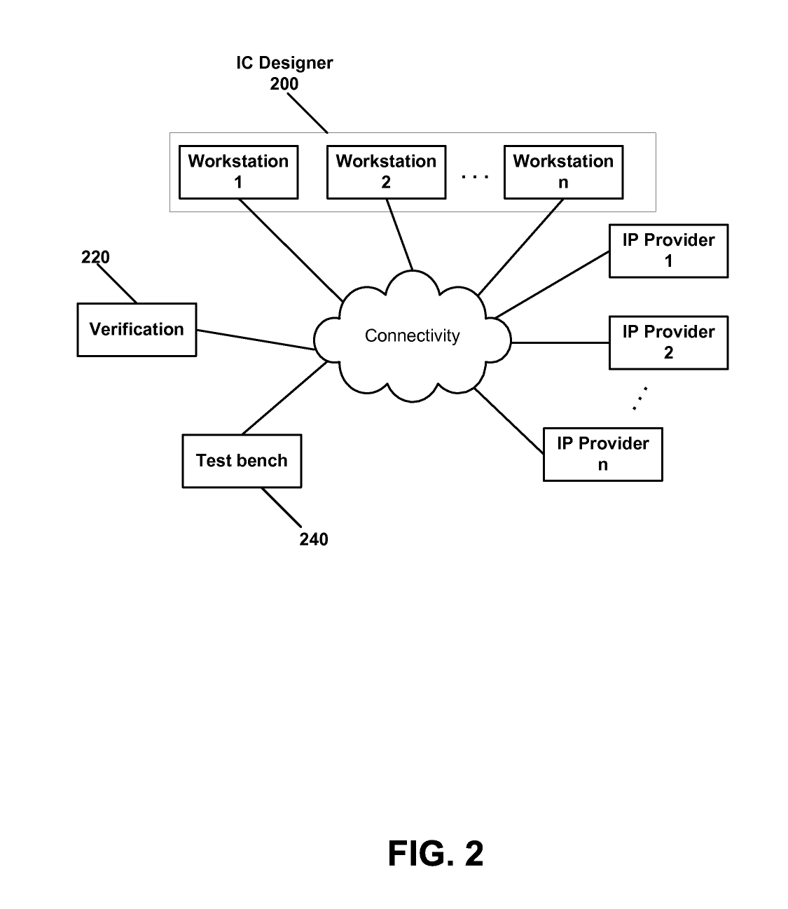

FIG. 2 depicts, at a high level, an environment in which an IC designer 200 (with design being carried out at any of one or more workstations 1, 2, . . . , n) may design an IC, test it through verification hardware and software 220, determine defect sources, and communicate the defect sources with the appropriate IP provider or providers selected from the group of n such providers shown in the Figure. In this way, the appropriate IP provider or providers can be informed of their responsibility for the defect(s), and then can perform the necessary debugging. The connectivity between an IC designer 200 and each IP provider 1-n is shown conceptually in one diagram here for convenience, but it should be understood that, in the usual case, IP providers would not be communicating directly with each other. The proprietary nature of what each IP provider may be providing to the IC designer would counsel against such connectivity. Rather, what is intended to be shown here is individual connectivity between an IC designer and each respective IP provider. Such connectivity may be local, or may be via the Internet, with or without secure communications between any of the workstations and a respective IP provider. The workstations need not be of any particular type, but should have the capability to run necessary electronic design automation (EDA) software and receive and implement design corrections. The blocks indicating the IP provider(s) may signify any number of types of workstations as well, so long as there is the capability to work on debugging of designs, and communicating the debugged designs appropriately to one or more of the other blocks shown. The IP provider's work to debug, and then to confirm with the customer that the debugging is complete (i.e. that the design works through an appropriately wide range of conditions), will be discussed in more detail below.

The verification block 220 and the test bench block 240 may be separate, as shown in FIG. 2, or may be together in a single station, or may be integral to one or more of the workstation and/or IP provider blocks depicted.

Each of the workstations referred to above may employ computer hardware of known types, including one or more processors, memory, and storage. All of these elements are well known to ordinarily skilled artisans, and may combined in any number of ways to effectuate defect isolation, attribution, and/or debugging according to aspects of the present invention. An exhaustive enumeration of the types and particular configurations of these elements is unnecessary to a proper understanding of the invention.

Verification and testing issues with respect to IP may arise in the following situation. For example, a smartphone manufacturer will want certain features and functionality in an SoC or other IC as described above, including memory management, graphics, image processing, and various forms of communications, among other things. As a result, the SoC/IC designer will incorporate different kinds of IP into the chip. Some of that IP may come from the smartphone manufacturer; in many cases, the IP will come from third party providers.

During testing, debugging invariably is necessary. When a problem is identified, it must be traced to its source, so that the entity that supplied the IP that caused the problem can fix it. However, because of the tremendous amount of data that gets input to and output from a chip, it can be very difficult to get a meaningful data dump to permit sufficient isolation of the problem source to convince the IP provider to take responsibility for fixing the problem.

Thus, it becomes necessary to present particular traffic patterns or signaling scenarios to the IP provider, so that the provider can reproduce the problem, and then fix it.

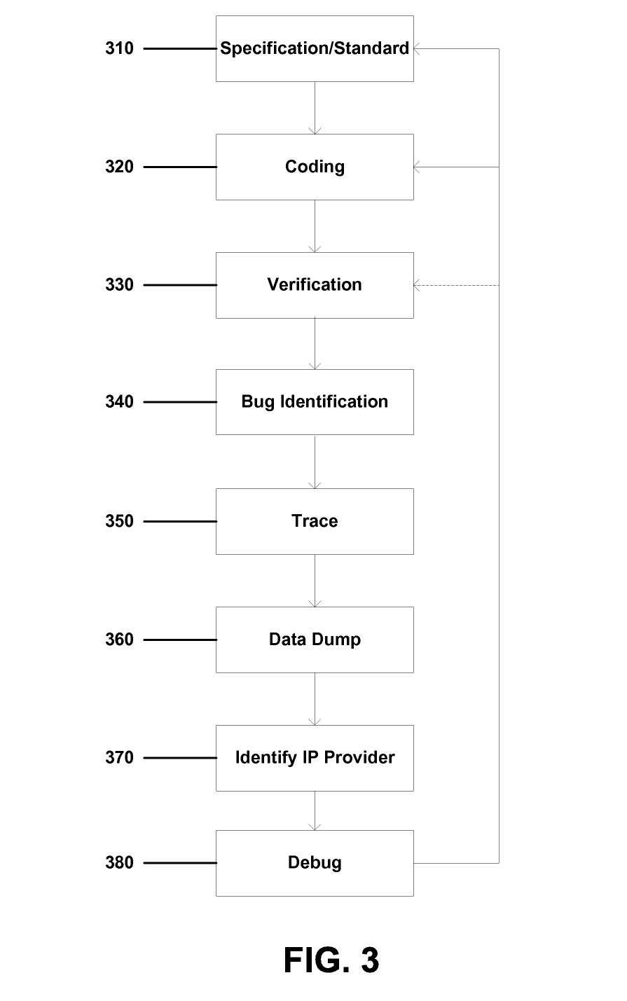

FIG. 3 shows a general flow of a debugging process that an IP provider and IP consumer will follow in working together to implement a particular type of IP in a device, perhaps in conjunction with an IC designer. In some instances, the IP consumer will be the IC designer, but for convenience, the IP consumer will be referred to alone. Initially, as shown at 310, the IP consumer will identify a specification or standard to be implemented in an IC. At 320, the IP provider will write code to implement the specification or standard. The code will be such that, once finalized, an IC fabricator will be able to take the code and lay out circuit paths and connections appropriately on a wafer.

At 330, the code that the IP provider has written may be run implemented in an emulator, to verify that the coded circuitry will operate according to the specification or standard. In order to do this, the emulator will exercise the coded circuitry in numerous ways, to ensure that various input combinations do not result in erroneous or ambiguous results. Almost invariably, the emulation never runs properly the first time, and so there are errors. At 340, the errors or defects are identified, perhaps by identifying erroneous outputs or erroneous timing. Once the erroneous outputs or timing are identified, either a trace is captured (350) or a data dump performed (360), or both. The sequence in which these are performed is not critical to the invention. In one embodiment, capture of the trace at 350 enables more judicious selection of data to be dumped at 360. The trace will be discussed in more detail below.

With the trace captured and the data dump carried out, at 370 the IP provider can be identified. Debugging, which the IP provider then would perform, occurs at 380. Flow may return to 320, where further coding is performed and the remainder of the just-described steps repeated, or flow may return to 330, as indicated by the dotted line, where further verification may be performed. In some instances, the identified defect may come from the specification or standard itself, in which case flow may return to 310 instead of 320 or 330. Particularly where the IP provider is the originator of the specification or standard, when a bug is identified as related to that specification or standard, the specification or standard itself may be the source of the bug.

In FIG. 3, the flow appears endless, because defect identification follows verification in all instances. However, if verification uncovers no further defects, the process would stop.

Even when the IP provider takes ownership of the problem and fixes it, it is necessary for the IP provider to demonstrate to the SoC designer, or to the ultimate customer (for example, the smartphone manufacturer), that the problem in fact is fixed, and will not recur. To do this, it is necessary to demonstrate operation of the repaired design under a number of different scenarios.

In order to ensure that a problem, once fixed, will not recur, it is important to take into account the possibility or probability that there may be different paths that a system (viewed in some respects as a finite state machine) may take to reach a certain state. The existence of these different paths can give rise to ambiguities, in which the IP provider, for example, may be able to recreate a state sequence resulting in a certain state, but still may not be able to verify that it was only that particular state sequence that yielded the result being observed.

As another part of this last aspect—proving that the defect will not recur—it is important to handle unpredictable behavior. While statistically, of course, the number of states, even in complicated systems, will be finite, though very large, there can be times when events like power disruptions or unusual actions by a user can place a system in an ambiguous state.

In one aspect of the invention, the ability of the verification equipment to employ dynamic triggering enables the setting of trigger conditions or to permit accounting for unpredictable behavior, including ambiguous states, in a design component. In an emulation, the dynamic triggering will prompt particular outputs which then may be monitored to see if they are as expected.

One way in which dynamic triggering may be effected involves the use of dynamic netlists. U.S. Pat. No. 7,379,861, incorporated herein by reference, describes dynamic netlists. A dynamic netlist can represent any type of logic or memory elements, such as combinational gates and state devices (e.g., registers) and may be used to define a trigger condition. Dynamic netlists can be loaded into an emulator and used to generate trigger signals when an IC design also is loaded into the emulator, so that the user can interact with the emulator irrespective of whether the design is presently being emulated.

As described in the above-mentioned patent, outputs of a dynamic netlist may be provided to trigger circuitry, which usually is fixed (i.e. is not changeable), and which outputs one or more trigger signals. The dynamic netlist determines the input or inputs to the fixed trigger circuitry, and so determines the outputs of that circuitry. Thus, together the dynamic netlist and the trigger circuitry constitute a dynamic trigger mechanism. In the context of a standard to be implemented, the dynamic trigger mechanism can provide standard-mandated inputs. The expected outputs from the IC design being emulated will be known from the standard. If there are bugs, then the outputs of the emulation will not be the expected outputs.

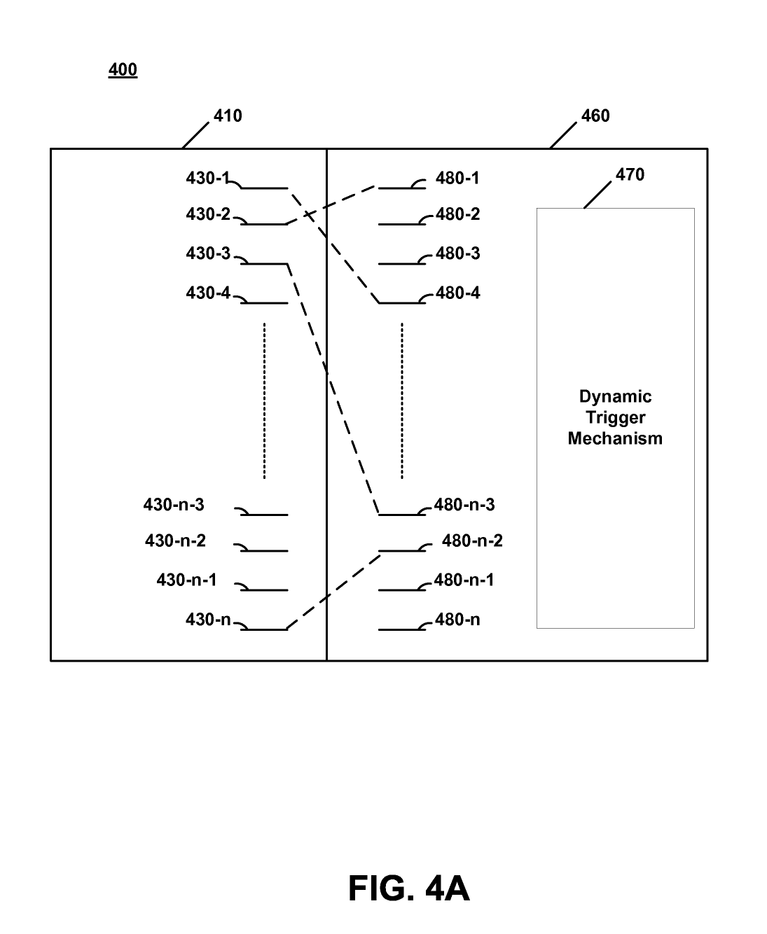

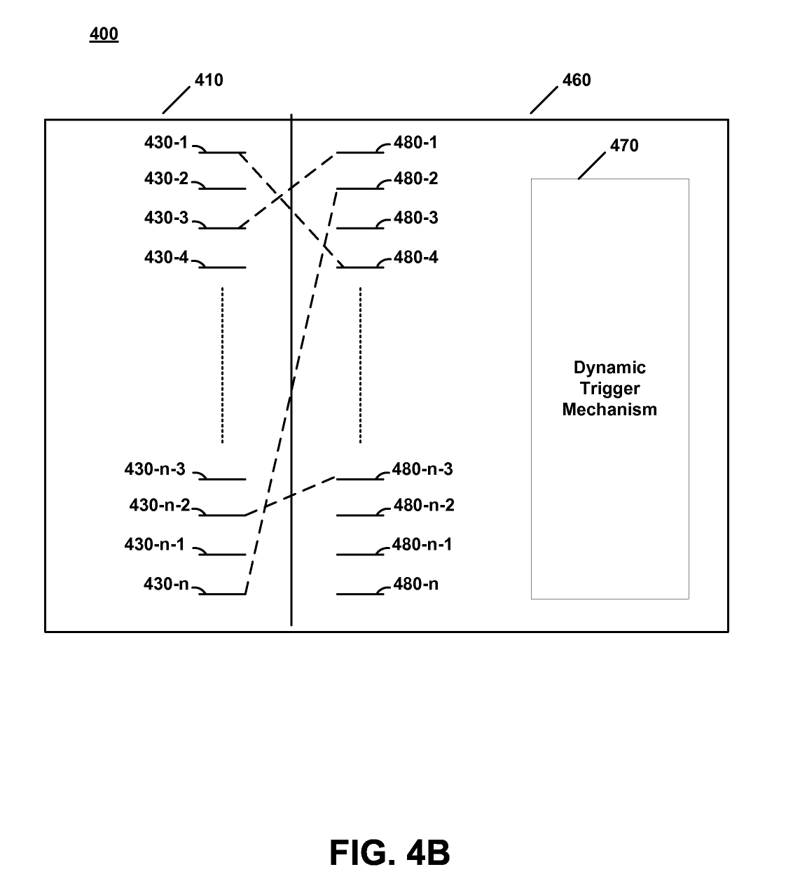

The just-discussed dynamic triggering capability, as part of an emulation, now will be discussed in more detail with respect to FIGS. 4A and 4B. FIG. 4A depicts two regions within a processing space. Region 410 on the left hand side of the Figure is a fixed region in which the IP from the provider may be stored and exercised. It is important that, during debugging, this IP not be disturbed. Rather, the exercise of the IP will be a function of preparation of a plurality of trigger conditions. The IP in this region 410 may be from a single provider, or may be from multiple providers. In either event, the process to be described will enable more specific identification of defects or, in the case of one aspect of the present invention, the attribution of the defects to particular IP, and hence to a particular IP provider or providers.

In FIG. 4A, lines 430-1, 430-2, 430-3, . . . , 430-n-2, 430-n-1, 430-n signify inputs to the IP in fixed region 410. By triggering different input combinations and monitoring outputs, it is possible to observe various aspects of behavior of the IP. A dynamic trigger mechanism of the type discussed above and/or as described in the above-mentioned patent may provide the inputs to the fixed region 410.

Region 460 on the right hand side of the Figure is a flexible or programmable region in the processing space. This region may contain the dynamic netlist referenced above, as part of dynamic trigger mechanism 470 depicted in the Figure and described above. In region 460, various trigger conditions may be set, through combinations of different inputs, via the dynamic trigger mechanism 480. Lines 480-1, 480-2, 480-3, . . . 480-m-2, 480-m-1, 480-m signify lines which, when connected in various ways to lines 430-1, etc. in region 410, will trigger different output signals and/or signal combinations, or different output line states.

A useful aspect of the flexible or programmable region 460 is that trigger conditions may be modified easily, in a dynamic fashion, through manipulation of conditions within the region 460, using the dynamic trigger mechanism 470. FIG. 4A shows one example of input combinations (via the dashed lines shown), while FIG. 4B shows a different configuration of dashed lines signifying another set of input combinations.

In the case of IP which is intended to comply with various aspects of a standard, the expected outputs largely will be known without requiring recourse to the IP provider. That is, a particular combination of inputs should yield standard-mandated outputs. The inputs may be inputs that are specified by the standard at issue. However, for purposes of identifying and resolving or avoiding potentially ambiguous states, for example, the inputs also usefully may vary from the standard, to account for unusual operating conditions. In a standards-based design, nonsensical outputs resulting from varying inputs may signify defects requiring correction.

It should be noted that there may be portions of a standard for which compliance is mandatory, and other portions for which compliance is optional. The IC designer, or the ultimate IP consumer (e.g. the smartphone manufacturer) may have a particular feature set in mind, in which compliance either with only mandatory portions of the standard, or with mandatory and certain optional portions of the standard, would be necessary. The IP provider will have received this information before designing the IP. The selection of mandatory and optional standards features may be proprietary to the IC designer or IP consumer, but need not be discernible from the IP provider's design.

In the case of IP that is designed to provide particular functionality, but in accordance with a proprietary design or feature set rather than a standard, outputs of the design will be a proprietary function of the inputs. An IP provider may be able to provide design-based sets of inputs and corresponding outputs (referred to earlier as IPSTRs), making it possible to exercise the design through selection of various combinations of inputs without revealing proprietary aspects of the IP design component. Again, it is possible to account for unusual operating conditions in emulated circuitry by programming region 460, using dynamic trigger mechanism 470, with input combinations that are different from what might occur in ordinary operation. In this fashion, it may be possible to identify ambiguous states.

As noted earlier, FIG. 4B is similar to FIG. 4A, except that there are different connections shown between the various lines 480-1 . . . 480-n on the programmable side and lines 430-1 . . . 430-n in the fixed region 410. Also as discussed, the different connections can provide a different trigger condition or set of trigger conditions. By monitoring the outputs of the IP in the fixed region 410, the portion or portions of the IP responsible for the defects can be identified.

As part of the process of exercising a circuit design, it is known in the electronic design automation art to use automatic test pattern generation (ATPG) to provide simulated signal sequences and combinations to identify conditions under which the design will fail. ATPG also can provide signal sequences and combinations that may be applied to fabricated circuits to determine circumstances under which the circuits will fail. One potential problem with ATPG, however, is the sheer volume of data that is presented. As circuitry becomes more and more complex, with greater numbers of inputs and outputs, the number of possible outcomes makes the task of poring through a data dump daunting and time-consuming, in many cases excessively so.

In addition and as an alternative to ATPG techniques, however, the selection of particular signal sequences and combinations may be useful in isolating defects in IP, and in debugging and proof thereof. To this end, the dynamic triggering made possible in accordance with one aspect of the present invention can limit the amount of data that needs to be reviewed. In the case of a standards-based design, the signal sets are likely to be relatively small and manageable, so that triggering is straightforward. Even in the case of proprietary designs, IP providers may have in mind particular signal sequences that would be useful in exercising the design to isolate and/or identify defects.

The IP tracing capability enables an IP consumer to locate and identify a problem within the boundary of a particular IP provider. For example, there may be situations in which IP for a particular function, e.g. graphics, may come from more than one IP provider. Setting trigger conditions (e.g. particular sets or combinations of standard-mandated inputs) appropriately enables the IP consumer to isolate the signals which are involved in the particular problem, and thereby pinpoint the source as being one IP provider and not another.

In an instance in which the various IP providers—including in some cases the IP consumer—have IP which is proprietary, and the IP consumer is seeking to debug, the trace information need not include either the IP consumer's proprietary information, or the proprietary information of any of the IP providers.

In some instances, the verification IP implementation itself may produce errors or ambiguities. Here again, the tracing capability enables a user to navigate around, or avoid the error or ambiguities.

In another aspect of the invention, where the IP at issue is protocol-specific, for example, in accordance with a particular standard or group of standards, it may be possible to avoid having to share any IP provider-specific information, thus enabling the IP provider to keep its own implementation confidential.

In accordance with one aspect of the invention, an EDA manufacturer may receive IPSTRs and make them part of appropriate EDA software, be it verification IP as for example in verification block 220 in FIG. 2, or a test bench such as test bench 240 in FIG. 2, or some other EDA software. In some instances, the EDA manufacturer may be able to generate and/or implement the IPSTRs on its own. In general, in accordance with an aspect of the invention, IPSTRs for an IP provider can be generated without revealing the provider's proprietary information. When an IC designer encounters errors, and outputs a test stream using IPSTRs, the IP provider will better be able to determine what signals are in question, and what code might have caused erroneous output. The IPSTRs aid the IC designer, showing the outputs to the IP provider, in helping the provider verify that the provider's own IP is the source of the error(s).

Because the IC designer will not have direct access to the IPSTRs, the designer is not privy to the IP provider's proprietary information. The provider need not worry that sensitive aspects of the IP will leak out to competitors.

In accordance with another aspect of the invention, the design of ICs with functionality that operates according to one or more standards also facilitates debugging, in that the outputs associated with a particular function, e.g. 802.11 wireless, Bluetooth™, or the like, will have expected or anticipated behavior. If the outputs of the provider's code turn out not to be as expected, e.g. because the code does not handle particular inputs or timings, the provider's IPSTRs can use the outputs, or a comparison between the actual and expected outputs, and trace the erroneous signals back through various states, including in some cases ambiguous states, and isolate the defect(s) to a particular IP provider.

The IP for these various components may come from a single source, but more often they come from multiple sources. In some instances, for example with various flavors of USB, other serial, parallel connectors, or video connectors, design and operation of the associated IP may be fairly readily traceable to a particular source. Consequently, if for example a USB connection fails, the device developer may be able to trace the source fairly readily to the IP provider who provided the design component for the USB portion of the device. However, in circumstances where, for example, memory operation may be involved with both general purpose processing and special purpose (e.g. video and/or graphics) processing, a video processing failure may not be readily traceable to the IP provider(s) who provided the design component(s) for video processing. Alternatively, the failure may be traceable potentially to multiple IP providers, but it may be difficult to discern, simply from the data, which of those providers is responsible for the IP causing the failure.

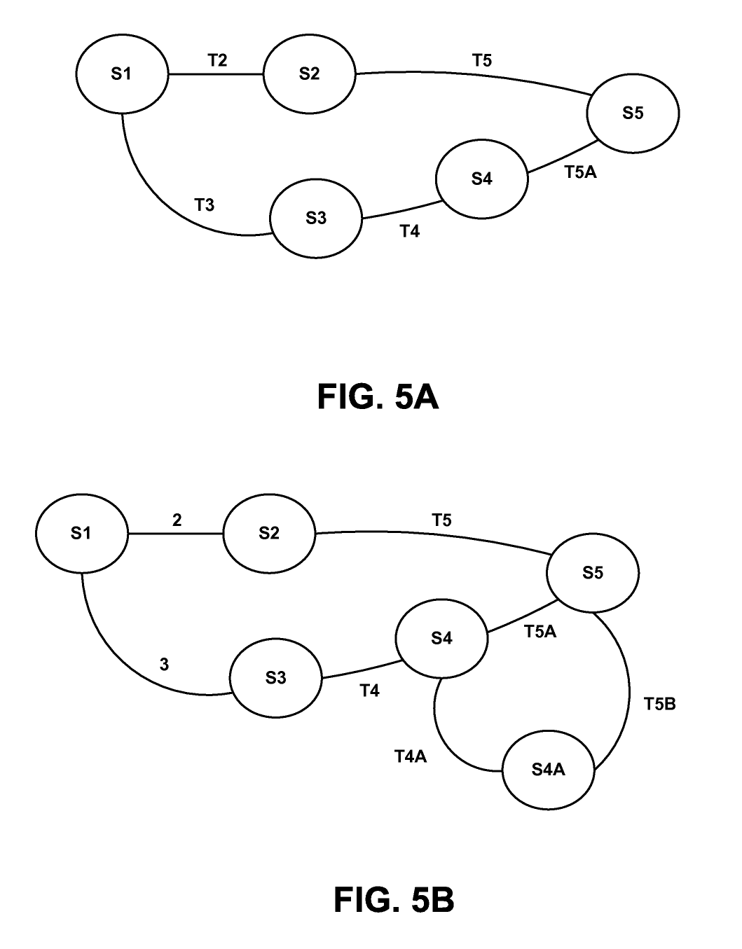

The approach described with respect to FIGS. 4A and 4B can be useful with respect to resolution of ambiguous states and ambiguous paths to particular states. FIGS. 5A and 5B show progressive states for a finite state machine, going from an initial state of S1 to a final state of S5 by different paths. Looking first at FIG. 5A, one path from S1 to S5 would be as follows: S1 to S2, via transition T2, to S5 via transition T5. Another path would be: S1 to S3 via transition T3, to S4 via transition T4, to S5 via transition T5A. It can be seen that, if the state S5 is erroneous, the cause could be, for example, either state S2 or transitions T2 and T5 in the first path; or state S3 or S4 in the second path, or any of transitions T3, T4, or T5A. If S2 results from IP from provider IP2 in FIG. 1, for example, and S3 results from IP from provider IP3 in FIG. 1, there can be two different sources of the erroneous state. Each IP provider could point back at the IC designer, or to the other IP provider, as the source of the error.

Even if S2 and S3 result from the same IP provider, there is ambiguity as to which IP from that provider would be the source of the error, so that the IP provider would have to undertake a substantial effort, poring through a substantial data dump potentially encompassing irrelevant conditions, in order to trace back through both state sequences to determine the source of the error.

In FIG. 5B, the situation is even more complicated by the provision of two potential paths from state S4 to state S5: One from S4 directly to S5 through transition T5A; and the other from S4 to S4A to S5 through transitions T4A and T5B. In this situation, there could be a still further IP provider implicated in the event of an erroneous state S5, and hence a further complication in identifying the IP provider responsible.

In accordance with one aspect of the invention, the ability to trace signals through different paths, and in particular, the ability to perform dynamic triggering in connection with particular states as shown in the state diagrams of FIGS. 5A and 5B, enable reliable identification of sources of erroneous states and/or signals in a design.

Even when the IP provider takes ownership of the problem and fixes it, it is necessary for the IP provider to demonstrate to the SoC/IC designer, or to the ultimate customer (the smartphone manufacturer), that the problem in fact is fixed, and will not recur. To do this, it is necessary to demonstrate operation of the repaired design under a number of different scenarios.

In order to ensure that a problem will not recur, it is important to take into account the possibility or probability that there may be different states through which a system may pass to reach a certain state, as exemplified in FIGS. 5A and 5B. The existence of these different paths can give rise to ambiguities, in which the IP provider, for example, may be able to recreate a state sequence resulting in a certain state, but still may not be able to verify that it was only that particular state sequence that yielded the result being observed. The IP provider's task may be yet more difficult because events like power disruptions or unusual actions by a user can place a system in an ambiguous state.

Once the IP provider has completed debugging the relevant portion of the IP responsible for errors, the IP provider needs to be able to test the debugged design. As noted earlier, it is known to use ATPG to provide a range of signaling scenarios, to exercise the debugged design and determine whether any defect recurs. However, there can be various problems with ATPG, including the volume of resulting data, and the potential generation of ambiguous states whose origins themselves may be ambiguous or otherwise hidden. In this event, the same techniques used to isolate and identify defects as described above may be applicable here. In particular, the trace or data dump that revealed a defect may be included or added for testing purposes. In one aspect, in the case of a standard-based IP component, the IP provider may program combinations of signals as indicated by mandatory and, where applicable, optional portions of the standard in region 460 in FIGS. 4A and 4B, using dynamic trigger mechanism 470, to verify the fix. In the case of a non-standard based IP component, the IP provider may program combinations of signals as indicated by IPSTRs, again using dynamic trigger mechanism 470.

While particular embodiments of the present invention have been described, it is to be understood that various different modifications within the scope and spirit of the invention are possible. The invention is limited only by the scope of the appended claims.

1. A computer-implemented method of isolating one or more defects in an integrated circuit (IC) design, the method comprising:
using a processor to identify an IC design defect during a debugging procedure; and
relating the IC design defect to an IC design component provided by a third party, wherein the relating comprises:
a) obtaining first data related to the third party IC design component;
b) using a processor to obtain second data related to the defect;
c) analyzing the first and the second data to identify a correlation between the two; and
d) based on results of the analyzing, attributing a source of the IC design defect to the third party IC design component.

2. A computer-implemented method as claimed in claim 1, wherein the first data comprises data related to signals that the IC design component would output in normal operation in response to a predetermined set of one or more input signals, and the second data comprises data related to signals that the IC design component output during a simulation or emulation, in response to the same predetermined set of one or more input signals.

3. A computer-implemented method as claimed in claim 2, wherein the second data consists of data that is not proprietary to the third party.

4. A computer-implemented method as claimed in claim 2, wherein the normal operation is operation according to at least one industry standard.

5. A computer-implemented method as claimed in claim 4, wherein the first data comprises signals according to the at least one industry standard.

6. A computer-implemented method as claimed in claim 5, wherein b) further comprises exercising the IC design component, without affecting the IC design component, by providing different combinations of inputs to the IC design component according to the industry standard.

7. A computer-implemented method as claimed in claim 2, wherein the normal operation is operation according to a proprietary design of the third party.

8. A computer-implemented method as claimed in claim 7, wherein the first data comprises signals according to the third party's proprietary design.

9. A computer-implemented method as claimed in claim 8, wherein b) further comprises exercising the IC design component, without affecting the IC design component, by providing different combinations of inputs to the IC design component using according to the third party's proprietary design.

10. A computer-implemented method as claimed in claim 1, wherein b) comprises:
b)i) programming different signal sequences for the IC design component; and
b)ii) exercising the IC design component using the signal sequences from b)i) to obtain the second data.

11. Apparatus for isolating one or more defects in an integrated circuit (IC) design, the apparatus comprising:
a memory; and
a processor programmed to:
identify an IC design defect during a debugging procedure; and
relate the IC design defect to an IC design component provided by a third party, by:
a) obtaining first data related to the third party IC design component;
b) obtaining second data related to the defect;
c) analyzing the first and the second data to identify a correlation between the two; and
d) based on results of the analyzing, attributing a source of the IC design defect to the third party IC design component.

12. Apparatus as claimed in claim 11, wherein the first data comprises data related to signals that the IC design component would output in normal operation in response to a predetermined set of one or more input signals, and the second data comprises data related to signals that the IC design component output during a simulation or emulation, in response to the same predetermined set of one or more input signals.

13. Apparatus as claimed in claim 12, wherein the second data consists of data that is not proprietary to the third party.

14. Apparatus as claimed in claim 12, wherein the normal operation is operation according to at least one industry standard.

15. Apparatus as claimed in claim 14, wherein the first data comprises signals according to the at least one industry standard.

16. Apparatus as claimed in claim 15, wherein b) further comprises exercising the IC design component, without affecting the IC design component, by providing different combinations of inputs to the IC design component according to the industry standard.

17. Apparatus as claimed in claim 12, wherein the normal operation is operation according to a proprietary design of the third party.

18. Apparatus as claimed in claim 17, wherein the first data comprises signals according to the third party's proprietary design.

19. Apparatus as claimed in claim 18, wherein b) further comprises exercising the IC design component, without affecting the IC design component, by providing different combinations of inputs to the IC design component according to the third party's proprietary design.

20. Apparatus as claimed in claim 11, wherein b) comprises:
b)i) programming different signal sequences for the IC design component; and
b)ii) exercising the IC design component using the signal sequences from b)i) to obtain the second data.

21. A computer implemented method as claimed in claim 1, wherein the first data is consistent with a design component specific tracing requirement provided by the third party.

22. A computer implemented method as claimed in claim 21, wherein the design component specific tracing requirements are implemented as part of EDA software that performs the debugging procedure.

23. A computer implemented method as claimed in claim 1, wherein the first data is consistent with a design component specific tracing requirement generated by EDA software that performs the debugging procedure.

24. A computer implemented method as claimed in claim 1, wherein the analyzing includes tracing signals through various state paths related to the IC design component.

25. A computer implemented method as claimed in claim 1, wherein the analyzing includes setting dynamic triggering conditions to provide input signals to the IC design component.

26. A computer implemented method as claimed in claim 25, wherein the input signals are generated from an industry standard.

27. A computer implemented method as claimed in claim 25, wherein the input signals are generated from information provided by the third party.
